(19) United States
(12) Patent Application Publication
(10) Pub. No.: US 2006/0198691 A1
(43) Pub. Date: Sep. 7, 2006

(54) Foam brush cover

(76) Inventor: Ralph Robert Tennis, Southaven, MS (US)

Correspondence Address: Larry W. McKenzie;Walker, McKenzie & Walker, P.C., Suite 434, 6363 Poplar Avenue, Memphis, TN, 38119-4896, US

(21) Appl. No.: 11/073,075

(22) Filed: Mar. 4, 2005

(51) Int. Cl. B43K 5/00

(52) U.S. Cl. 401/205; 401/202

(57) ABSTRACT

A cover for the head of a foam brush. The cover includes a bag having a face side and a back side joined together to form an interior cavity, and includes structure for securing the bag to the head of the brush. The bag has a mouth for allowing ingress into the interior cavity and has a plurality of weep slots in the face side thereof allowing foam from the head of the brush to pass therethrough.

### BACKGROUND OF THE INVENTION

1. Field of the Invention

The present invention relates, in general, to a removable cover for a foam brush of the type typically used to cleanse vehicles in self service car washers and the like by rubbing or scrubbing the brush against the surface of the vehicle using a “foam” consisting of soap and water, etc.

2. Background Art

A typical self service car wash (“car” being used herein to broadly mean a “vehicle” of any type and specifically includes automobiles, trucks, motorcycles, trailers, boats, campers, etc.) typically includes a foam brush for allowing the car to be rubbed and scrubbed with “foam” soap suds, etc. Such foam brushes include a head portion having a face surface for being rubbed or scrubbed against the surface of the vehicle being washed, a hose/handle portion extending from the head portion for allow a soap/water mixture to be delivered to the head in a manner which causes “foam” to be expelled from the face surface of the head portion, and for allowing a person to easily rub or scrub the face surface of the head portion against the surface of a vehicle being washed. While such foam brushes allows the surface of vehicles to be quickly and satisfactorily washed, if the face surface of the head portion becomes dirty with sand, mud, gravel, etc., the surface of the vehicle being washed is likely to be scratched or damaged.

A preliminary patentability search in Class 15, subclasses 230.19, 227, 247 and 235, and in Class 401, subclasses 289 and 291, produced the following references, some of which may be relevant to the present invention:

Wiegert, U.S. Pat. No. 1,817,050, issued Aug. 4, 1931, discloses an automobile brush including a head, and a bag made of a very loose textured material for covering the head without danger of scratching or injuring the surface of the automobile.

Rich, U.S. Pat. No. 2,564,031, issued Aug. 14, 1951, discloses an automobile and window washer including a flexible head and a sheep pelt element removably secured to the head.

Dewey, U.S. Pat. No. 2,756,449, issued Jul. 31, 1956, discloses a device for washing automobiles including a washing head having a resilient pad and a sheepskin hood or the like for removably covering the resilient pad. The hood has a plurality of perforations for allowing water to pass therethrough.

Flynn, U.S. Pat. No. 4,945,599, issued Aug. 7, 1990, discloses a terry cloth cap for fitting over the head of a sponge mop.

Buck et al, U.S. Pat. No. 5,042,105, issued Aug. 27, 1991, discloses a terry cloth cover for a mop head. The cover is tubular and is closed at one end with the other end open for being fitted over the mop head. Holes are provided on one side of the cover to fit over the conventional handle and studs of the mop. The other side of the cover (the side for being rubbed against the floor) is free of apertures, etc.

Wirth, U.S. Pat. No. 5,177,831, issued Jan. 12, 1993, discloses a cloth covered sponge mop.

Hurell, U.S. Pat. No. 6,389,637 issued May 21, 2002, discloses an absorbent broom cover.

Alex, U.S. Patent Application Publication No. US 2002/0179115 A1, published Dec. 5, 2002, discloses a cloth pouch for a scrub brush. The pouch includes an opened bag having an opened top for receiving the head of a scrub brush, and a cinch member for closing the opened top of the bag about the head of the scrub brush.

Bockes, U.S. Patent Application Publication No. US 2004/0078912 A1, published Apr. 29, 2004, discloses a washer for canopy/cab truck windows, the washer including a cylindrical shaped brush and a cleaning mitt covering the brush head to provide a non-abrasive cleaning surface.

Nothing in the know prior art, either singly or in combination, discloses or suggests the present invention.

### BRIEF SUMMARY OF THE INVENTION

The present invention is a cover for the head of a foam brush. The cover includes a bag having a face side and a back side joined together to form an interior cavity; and securing means for securing the bag to the head of the foam brush. The bag having a mouth for allowing ingress into the interior cavity, and having a plurality of weep slots in the face side thereof for allowing foam to weep or pass from the foam brush therethrough.

The object of the present invention is to provide a simple, inexpensive cover made out of terry cloth or the like that can be brought to a self-service car wash or purchased at the, self-service car wash via a vending machine, etc., by a person using the self-service car wash to wash a vehicle, etc., and to allow the head of the typical foam brush at the self-service car wash to be covered so as not to damage or scratch the finish of the vehicle when rubbed with the head of the foam brush, while allowing foam from the head of the foam brush to freely pass therethrough.

### BRIEF DESCRIPTION OF THE SEVERAL VIEWS OF THE DRAWINGS

FIG. 1 is a top plan view of the brush cover of the present invention.

FIG. 2 is a sectional view of the brush cover of the present invention as taken on line 2-2 of FIG. 1.

FIG. 3 is a bottom plan view of the brush cover of the present invention.

FIG. 4 is a sectional view of the brush cover of the present invention as taken on line 4-4 of FIG. 4, but showing the brush cover combined with, and covering, the head of a brush and with soap suds from the brush being expelled therethrough.

### DETAILED DESCRIPTION OF THE INVENTION

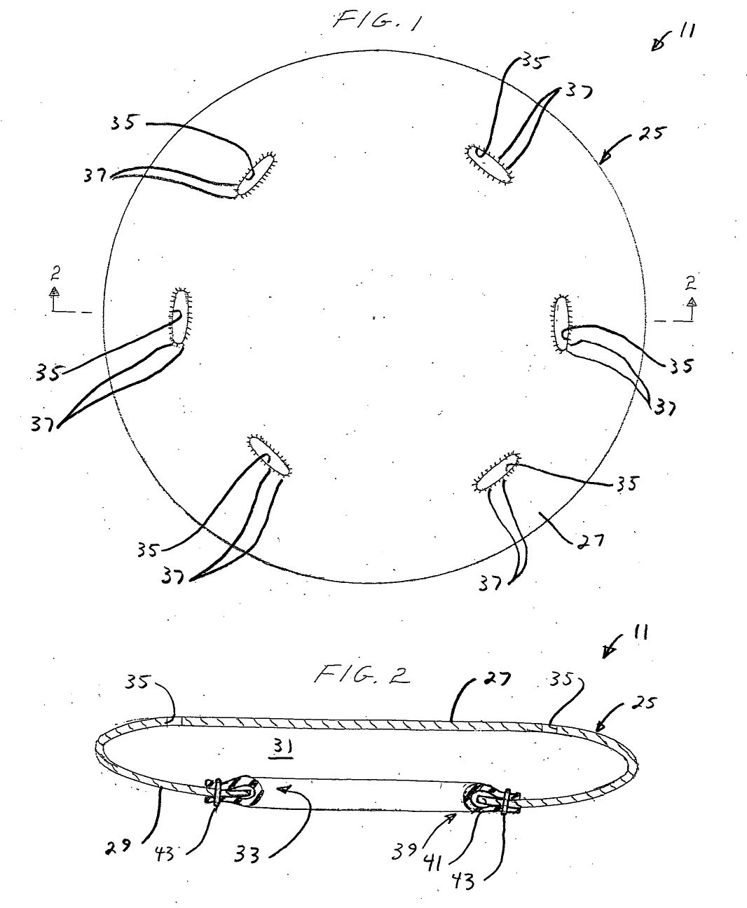

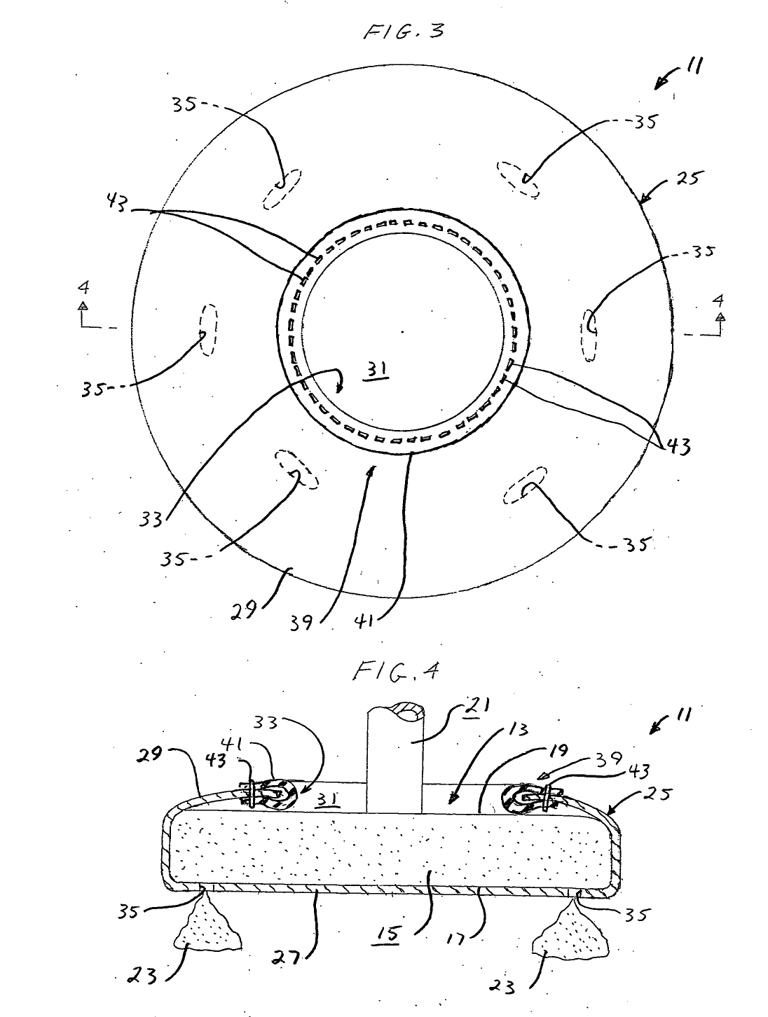

A preferred embodiment of the cover for the head of a foam brush of the present invention is shown in FIGS. 1-4, and identified by the numeral 11. The cover 11 is especially designed for use with a typical foam brush 13 having a head 15 with a face side 17 and a back side 19, and having a pole handle 21 extending from the back side 19 of the head 15 and connecting to a soap/water source or supply so that a foamy soap/water solution (hereafter foam 23) will be expelled from the face side 17 of the head 15 and so that the user of the brush 13 can hold the brush 13 by the handle 21 and rub the face side 17 of the head 15, and the foam 23, against the surface of a vehicle (i.e., an automobile, truck, recreational vehicle, trailer, boat, etc.) to scrub and clean the surface of the vehicle, etc., as will now be apparent to those skilled in the art.

The cover 11 includes a bag 25 having a face side 27 and a back side 29 joined together to form an interior cavity 31. The bag 25 has a mouth 33, preferably in the center of the back side 29, for allowing ingress into the interior cavity 31. The bag 25 has a plurality of weep slots 35 in the face side 27 thereof for allowing foam 23 form the head 15 of the brush 13 to pass, or weep, therethrough. The slots 35 are preferably substantially evenly spaced about the face side 27 of the bag 25, and each slot 35 is preferably reinforced with buttonhole stitches 37 or the like as will now be apparent to those skilled in the art. The bag 25 may be constructed out of an absorbent material, such as a pile fabric, preferably terry cloth, in various specific designs and sizes, and in a manner which will hereinafter become apparent.

The cover 11 includes securing means 39 for securing the bag 25 to the head 15 of the brush 13. The securing means 39 preferably includes an elastic band 41 attached around the mouth 33 of the bag 25 to pull the bag 25 around the head 15 of the brush 13. The elastic band 41 may be a thin, flat strip of off-the-shelf elastic material, folded over and sewn to the lips of the mouth 33 of the bag 25 using stitches 43 or the like, with the ends of the elastic strip sewn together to form a continuous loop or ring as shown in FIGS. 2 and 4.

To use the cover 11 in combination with the brush 13, the bag 25 is merely pulled over the head 15 of the brush 13. That is, the head 15 can be inserted through the mouth 33 of the bag 25 while stretching the elastic band 41 as wide as necessary to allow the head 15 to pass easily therethrough, so that the head 15 will be positioned within the interior cavity 31 of the bag 25 with the face side 17 of the head 15 positioned adjacent the face side 27 of the bag 25, and with the handle 21 extending through the mouth 33 as clearly shown in FIG. 4. The soap/water source or supply can then be activated (e.g., via a typical coin-activated mechanism well known to those skilled in the art) so that the foam 23 will be expelled from the face side 17 of the head 15 and through the slots 35 in the face side 27 of the bag 25 (see FIG. 4) so that the user of the brush 13 can hold the brush 13 by the handle 21 and rub the face side 17 of the head 15, and the foam 23, against the surface of a vehicle without danger of damage to the surface of the vehicle caused by a dirty face side 17 of the brush 13, as will now be apparent to those skilled in the art. After one or more uses, the cover 11 can be easily removed from the heard 15 by merely pulling the head 15 back through the mouth 33, and the cover 11 can be washed to insure that it is clean for the next use.

Although the present invention has been described and illustrated with respect to a preferred embodiment and a preferred use therefor, it is not to be so limited since modifications and changes can be made therein which are within the full intended scope of the invention.

1. A cover for the head of a foam brush of the type that expels foam from the head thereof, said cover comprising:
(a) a bag having a face side and a back side joined together to form an interior cavity; said bag having a mouth for allowing ingress into said interior cavity; said bag having a plurality of weep slots in said face side thereof for allowing foam to pass therethrough; and
(b) securing means for securing said bag to the head of the brush.

2. The cover of claim 1 in which each of said slots are reinforced with buttonhole stitches.

3. The cover of claim 1 in which said bag is constructed out of an absorbent material.

4. The cover of claim 1 in which said bag is constructed out of a pile fabric.

5. The cover of claim 1 in which said bag is constructed out of terry cloth.

6. The cover of claim 1 in which said securing means includes an elastic band attached around said mouth of said bag to pull said bag around the head of the brush.

7. A cover for the head of a foam brush of the type that expels foam from the head thereof, said cover comprising:
(a) a cloth bag having a face side and a back side joined together to form an interior cavity; said bag having a mouth for allowing ingress into said interior cavity; said bag having a plurality of elongated weep slots in said face side thereof for allowing foam from the head of the foam brush to pass therethrough; and
(b) an elastic band attached to said bag around said mouth thereof to pull said bag around the head of the foam brush and to secure said bag to the head of the foam brush.

8. In combination:
(a) a foam brush comprising:
(i) a head with a face surface and a back surface, and
(ii) a pole handle attached to and extending from said back surface of said head to a soap/water source and allowing a soap/water mixture to expel foam from said head thereof; and
(b) a cover covering said head of said foam brush; said cover comprising:
(i) a cloth bag having a face side and a back side joined together to form an interior cavity holding said head of said foam brush; said bag having a mouth through which said pole handle of said foam brush extends from said back surface of said head; said bag having a plurality of elongated weep slots in said face side thereof allowing foam from said head of said foam brush to pass therethrough; and
(ii) an elastic band attached to said bag around said mouth thereof, pulling said bag around said head of said foam brush, and securing said bag to said head of said foam brush.
